(19) United States
(12) Patent Application Publication
(10) Pub. No.: US 2014/0178112 A1
(43) Pub. Date: Jun. 26, 2014

(54) HEATING UNIT, METHOD OF MANUFACTURING THE SAME, FIXING APPARATUS, AND ELECTROPHOTOGRAPHIC IMAGE FORMING APPARATUS USING THE FIXING APPARATUS

(71) Applicant: Samsung Electronics Co., Ltd., Suwon-si (KR)

(72) Inventors: Sun-hyung LEE, Hyeonbuk-myeon (KR); Dong-woo LEE, Seoul (KR); Ju-hyoeng LEE, Busan (KR); Sang-uk JEON, Yongin-si (KR)

(73) Assignee: SAMSUNG ELECTRONICS CO., LTD., Suwon (KR)

(21) Appl. No.: 13/905,781

(22) Filed: May 30, 2013

(30) Foreign Application Priority Data
Dec. 24, 2012 (KR) 10-2012-0152505

(51) Int. Cl. G03G 15/20

(52) U.S. Cl. CPC G03G 15/2053
USPC 399/329; 29/611

(57) ABSTRACT

The fixing apparatus includes a back-up member which is disposed outside a rotational and flexible endless belt and moves the endless belt, and a heating unit which is located inside the endless belt to face the back-up member and forms a fixing nip, and heats the endless belt at the fixing nip. The heating unit includes a support member having a recess formed in one surface thereof, current-supply electrodes respectively disposed at both ends of a length of the recess, and a heating element which is formed in the recess to contact the current-supply electrodes, the heating element including a base polymer and an electrically-conductive filler distributed in the base polymer to form an electrically-conductive network in a base polymer.

### CROSS-REFERENCE TO RELATED APPLICATIONS

This application claims the benefit of Korean Patent Application No. 10-2012-0152505, filed on Dec. 24, 2012, in the Korean Intellectual Property Office, the disclosure of which is incorporated herein in its entirety by reference.

### BACKGROUND

1. Field

The present disclosure relates to a heating unit, a method of manufacturing the same, a fixing apparatus, and an electrophotographic image forming apparatus using the fixing apparatus.

2. Description of the Related Art

An electrophotographic image forming apparatus supplies toner to an electrostatic latent image formed on an image receptor to form a visual toner image on the image receptor, transfers the toner image to a recording medium, and fixes the transferred toner image to the recording medium. Toner is manufactured by adding various functional additives such as a coloring agent to a base resin. A fixing process includes a process of applying heat and pressure to the toner.

A fixing apparatus includes a heating roller and a pressing roller engaging with each other to form a fixing nip. The heating roller is heated by a heating source such as a halogen lamp. While the recording medium, to which the toner is transferred, passes through the fixing nip, heat and pressure are applied to the toner. In such a fixing apparatus, as a heating source heats the heating roller by using air as a medium, it is difficult to expect high heat efficiency. Additionally, the halogen lamp emits a lot of visible rays which do not help heating a lot, compared to infrared lights which are effective for heating. Thus, a lot of power is consumed. Furthermore, since a heat capacity of a heated element in the form of a roller, that is, a heating roller is high, a rapid rise in temperature may not be easily obtained.

### SUMMARY

Additional aspects and/or advantages will be set forth in part in the description which follows and, in part, will be apparent from the description, or may be learned by practice of the invention.

The present disclosure provides a fixing apparatus in which a rapid rise in temperature may be obtained, and an image forming apparatus using the same.

The present disclosure also provides a fixing apparatus in which a design freedom in the form of a fixing nip is improved, and an image forming apparatus using the same.

The present disclosure also provides a heating unit in which a support member for forming a fixing nip and a heater are formed integrally with the support member, and a method thereof.

According to an aspect, there is provided a heating unit for a fixing apparatus, the heating unit including: a support member having a recess formed in one surface thereof; current-supply electrodes respectively disposed at both ends of a length of the recess; and a heating element which is formed in the recess to contact the current-supply electrodes, the heating element including a base polymer and an electrically-conductive filler distributed in the base polymer to form an electrically-conductive network in a base polymer.

The heating element may be filled in the recess in the form of a solution in which a polymer precursor for forming the base polymer and the electrically-conductive filler are distributed, and may be hardened and formed in the recess.

The support member may be formed of a porous material.

The heating unit may further include an insulating layer which covers the heating element.

According to an aspect, there is provided a method of manufacturing a heating unit for a fixing apparatus, the method including: preparing a support member having a recess; disposing current-supply electrodes respectively at both ends of a length of the recess; filling the recess with a solution in which a polymer precursor and an electrically-conductive filler are distributed; and by hardening the polymer precursor through a heat treatment process, forming a heating element including a base polymer and an electrically-conductive filler distributed in the base polymer to form an electrically-conductive network in a base polymer, in the recess.

The filling of the recess may include penetrating the solution into cells exposed at a bottom of the recess.

The method of manufacturing a heating unit for a fixing apparatus may further include an insulating layer which covers the heating layer.

According to an aspect, there is provided a fixing apparatus, including a endless belt which is rotatable and flexible; a back-up member which is disposed outside the endless belt and moves the endless belt; and a heating unit which is located inside the endless belt to face the back-up member and form a fixing nip, and heats the endless belt at the fixing nip, wherein the heating unit may include a support member in which a recess is provided at a location corresponding to the fixing nip; and a heater which includes current-supply electrodes respectively disposed at both ends of a length of the recess, and a heating element which is formed in the recess to contact the current-supply electrodes, the heating element including a base polymer and an electrically-conductive filler distributed in the base polymer to form an electrically-conductive network in a base polymer.

The heating element may be filled in the recess in the form of a solution in which a polymer precursor for forming the base polymer and the electrically-conductive filler are distributed, and is hardened and formed in the recess.

The support member may be formed of a porous material.

The heater may contact the inside surface of the endless belt.

A heat-conductive plate may be interposed between the heater and the endless belt. A width of the heat-conductive plate may be greater than a width of the fixing nip.

The fixing nip may include at least two nip areas which form an angle with each other.

A protrusion area, which protrudes towards the back-up member, may be provided near an exit of the fixing nip.

The recess may extend to a location which corresponds to the protrusion area, and the heater may be formed to extend to a location which corresponds to the protrusion area.

A heat-conductive plate may be interposed between the heater and the endless belt, and the heat-conductive plate may extend to a location which corresponds to the protrusion area.

The heater may include an insulating layer which covers the heating layer.

According to an aspect, there is provided an image forming apparatus including a printing unit for forming a visual toner image on a recording medium; and the fixing apparatus fixing the toner image to the recording medium.

The heater may include an insulating layer covering the heating layer.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a schematic configuration diagram illustrating an embodiment of an electrophotographic image forming apparatus;

FIG. 2 is a cross-sectional view of an embodiment of a fixing apparatus applied to an embodiment of the electrophotographic image forming apparatus of FIG. 1;

FIG. 3A is a cross-sectional view of an embodiment of an endless belt;

FIG. 3B is a cross-sectional view of another embodiment of an endless belt;

FIG. 4 is a detailed diagram illustrating portion A of FIG. 2;

FIG. 5 is a cross-sectional view of the fixing apparatus taken along line B-B′ of FIG. 2;

FIG. 6 is a detailed diagram illustrating an example of a status of bonding a support member and a heating element;

FIG. 7 is a cross-sectional view of a modified embodiment of the fixing apparatus of FIG. 2, illustrating a heat-conductive plate interposed between a belt and a heater;

FIG. 8 is a cross-sectional view of another embodiment of a fixing apparatus; and

FIG. 9 is a cross-sectional view of a modified embodiment of the fixing apparatus of FIG. 8, illustrating a heat-conductive plate interposed between a belt and a heater.

### DETAILED DESCRIPTION

The present disclosure will now be described more fully with reference to the accompanying drawings, in which exemplary embodiments of a heating unit, a method of manufacturing the same, a fixing apparatus, and an electrophotographic image forming apparatus using the fixing apparatus are shown.

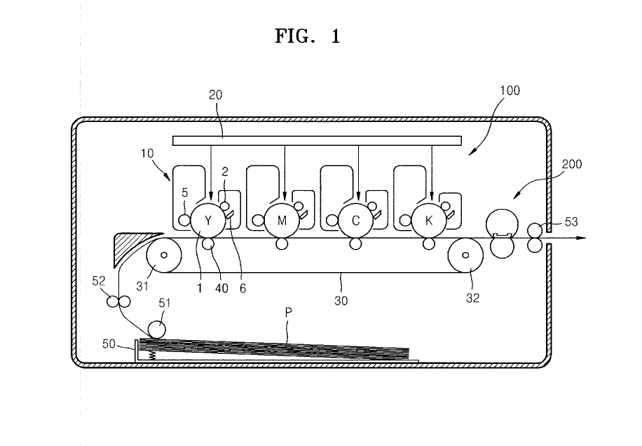

FIG. 1 is a schematic configuration diagram illustrating an embodiment of an electrophotographic image forming apparatus. Referring to FIG. 1, the electrophotographic image forming apparatus includes a printing unit 100 for forming a visible toner image on a recording medium P, for example, paper, and a fixing apparatus 200 for fixing the toner image to the recording medium P. The printing unit 100, in the present embodiment, forms a color toner image by using an electrophotographic method.

The printing unit 100 may include a plurality of photoconductive drums 1, a plurality of developing devices 10, and a paper-transporting belt 30. The photoconductive drum 1 is an example of a photoreceptor on the surface of which an electrostatic latent image is formed. The photoconductive drum 1 may include a conductive metal pipe and a photo-receiving layer, which is formed on an outer circumference of the conductive metal pipe. The plurality of developing devices 10 respectively correspond to the plurality of photoconductive drums 1, and form a toner image on a surface of the plurality of photoconductive drums 1 by supplying toner to an electrostatic latent image, formed on the plurality of photoconductive drums 1, and developing the electrostatic latent image. Each of the plurality of developing devices 10 may be replaced, separately from the plurality of photoconductive drums 1. Additionally, each of the plurality of developing devices 10 may be in the form of a cartridge which includes the photoconductive drum 1.

For color printing, the plurality of developing devices 10 may include a plurality of developing devices 10Y, 10M, 10C, and 10K which contain yellow Y, magenta M, cyan C, and black K toners, respectively. However, the plurality of developing devices 10 are not limited thereto, and they may further include developing devices which contain toners of various colors such as light magenta, white, and the like. Hereinafter, an image forming apparatus, which includes the plurality of developing devices 10Y, 10M, 10C, and 10K, is described. Unless otherwise specified, references with Y, M. C, and K refer to elements for printing an image by using yellow Y, magenta M, cyan C, and black K toners.

The developing device 10 develops an electrostatic latent image into a visible toner image by supplying toner, contained therein, to an electrostatic latent image formed on the photoconductive drum 1. The developing device 10 may include a developing roller 5. The developing roller 5 functions to supply toner in the developing device 10 to the photoconductive drum 1. A developing bias voltage may be applied to the developing roller 5. A regulator, not illustrated, regulates an amount of toner which is supplied to a developing area, in which the photoconductive drum 1 and the developing roller 5 face each other, by the developing roller 5.

In a case of employing a two-component developing method, a magnetic carrier is contained in the developing device 10, and the developing roller 5 is located to separate from the photoconductive drum 1 by tens through hundreds of microns. Although not illustrated, the developing roller 5 may be formed to include a magnetic roller in a hollow cylindrical sleeve. Toner is attached to a surface of the magnetic carrier. The magnetic carrier is attached to a surface of the developing roller 5 and transported to the developing area in which the photoconductive drum 1 and the developing roller 5 face each other. Only toner is supplied to the photoconductive drum 1 by the developing bias voltage applied between the developing roller 5 and the photoconductive drum 1 so that an electrostatic latent image, formed on a surface of the photoconductive drum 1, is developed into a visible toner image. In the case of employing a two-component developing method, the developing device 10 may include an agitator (not illustrated) for mixing and agitating the toner with the magnetic carrier, and transporting the mixed and agitated toner and magnetic carrier to the developing roller 5. The agitator may be, for example, an auger, and the developing device 10 may include a plurality of agitators.

In a case of employing a mono-component developing method in which the magnetic carrier is not used, the developing roller 5 may rotate in contact with the photoconductive drum 1, or rotate at a position separate from the photoconductive drum 1 by tens through hundreds microns. The developing device 10 may further include a supply roller (not illustrated) for attaching toner to a surface of the developing roller 5. A supply bias voltage may be applied to the supply roller. The developing device 10 may further include an agitator (not illustrated). The agitator may agitate and triboelectrically charge the toner. The agitator may be, for example, an auger.

The charging roller 2 is an example of a charger for charging the photoconductive drum 1 so that the photoconductive drum 1 has a uniform surface potential. A charging brush or a corona charger may be employed, instead of the charging roller 2.

A cleaning blade 6 is an example of a cleaning element for removing toner and a foreign substance remaining on a surface of the photoconductive drum 1 after a transfer process. Instead of the cleaning blade 6, a different type of cleaning device, such as a rotating brush, may be used.

An example of a developing method used by an image forming apparatus, according to an embodiment of the present invention, is specifically described. However, the present invention is not limited thereto, and various modifications and changes may be made, with respect to a developing method.

An exposing unit 20 emits light, modulated in correspondence to image information, to photoconductive drums 1Y, 1M, 1C, and 1K which will be described later, so as to form electrostatic latent images which respectively correspond to yellow Y, magenta M, cyan C, and black K images on the photoconductive drums 1Y, 1M, 1C, and 1K. An example of the exposing unit 20 may include a laser scanning unit (LSU) which uses a laser diode as a light source, and a light-emitting diode (LED) scanning unit which uses an LED as a light source.

The paper-transporting belt 30 supports and transports the recording medium P. The paper-transporting belt 30 may be supported by, for example, supporting rollers 31 and 32, and circulates. A plurality of transfer rollers 40 are disposed to respectively face the plurality of photoconductive drums 1Y, 1M, 1C, and 1K with the paper-transporting belt 30 therebetween. The plurality of transfer rollers 40 are an example of a transfer unit which transfers a toner image from the plurality of photoconductive drums 1Y, 1M, 1C, and 1K to the recording medium P supported by the paper-transporting belt 30. A transfer bias voltage is applied to the plurality of transfer rollers 40, so as to transfer a toner image to the recording medium P. Instead of the transfer rollers 40, a corona transfer unit or a pin-scorotron type transfer unit may be used.

Recording medium P may be picked up from a recording medium tray 50 by a pick-up roller 51, transported by a pair of transporting rollers 52, and thus, attach to the paper-transporting belt 30, for example, by an electrostatic force.

The fixing apparatus 200 applies heat and/or pressure to the image transferred to the recording medium P, thus fixing the image to the recording medium P. The recording medium P, passing through the fixing apparatus 200, is discharged by a pair of discharge rollers 23.

Based on the configuration described above, the exposing unit 20 emits lights, modulated in correspondence to image information of each color, to the plurality of photoconductive drums 1Y, 1M, 1C, and 1K, so as to form an electrostatic latent image. The plurality of developing devices 10Y, 10M, 10C, and 10K supply the yellow Y, magenta M, cyan C, and black K toners to the electrostatic latent image, formed on the plurality of photoconductive drums 1Y, 1M, 1C, and 1K, thus forming visible toner images respectively on a surface of the plurality of photoconductive drums 1Y, 1M, 1C, and 1K. The recording medium P, loaded on the recording medium tray 50, is supplied to the paper-transporting belt 30 by the pick-up roller 51 and the pair of transporting rollers 52 and maintained on the paper-transporting belt 30, for example, by using an electrostatic force. The toner images of yellow Y, magenta M, cyan C, and black K are sequentially transferred to the recording medium P, which is transported by the paper-transporting belt 30, by applying a transfer bias voltage to the transfer roller 40. When the recording medium P passes through the fixing apparatus 200, the toner image is fixed on the recording medium P by heat and pressure. The recording medium P, on which the toner image is completely fixed, is discharged by the pair of discharge rollers 53.

The electrophotographic image forming apparatus of FIG. 1 employs a method of directly transferring a toner image, which is developed on the plurality of photoconductive drums 1Y, 1M, 1C, and 1K, to the recording medium P supported by the paper-transporting belt 30. However, the present invention is not limited thereto. For example, a method of intermediately transferring a toner image, developed on the plurality of photoconductive drums 1Y, 1M, 1C, and 1K, to an intermediate transfer belt, and then, transferring the toner image to the recording medium P may be used. The intermediate transferring method is well known to one of ordinary skill in the art. Thus, detailed description thereof is not provided here.

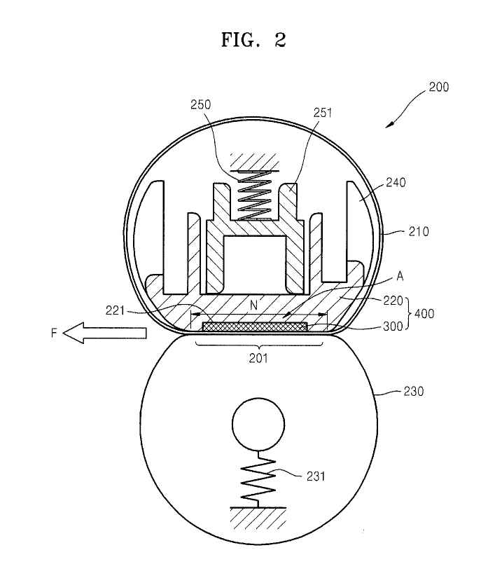

The fixing apparatus 200 applies heat and pressure to a toner image, thus fixing the toner image to the recording medium P. In order to improve a printing speed and reduce energy consumption, it is desirable to keep a heated portion of the fixing apparatus 200 to have a low heat capacity. For this, the fixing apparatus 200, employing an endless belt in the form of a thin film as the heated portion, is employed. FIG. 2 is a cross-sectional view of an embodiment of the fixing apparatus 200.

Referring to FIG. 2, the fixing apparatus 200 includes an endless belt 210, a heating unit 400 which is located inside the endless belt 210, and a back-up member 230 which is disposed outside the endless belt 210 to face the heating unit 400, and thus, forms a fixing nip 201. The back-up member 230 is rotated as the back-up member 230 and the heating unit 400 mutually press each other, having the endless belt 200 therebetween. Thus, the endless belt 210 may move. The heating unit 400 faces the back-up member 230, thus forming the fixing nip 201, and heats the endless belt 210 at the fixing nip 201.

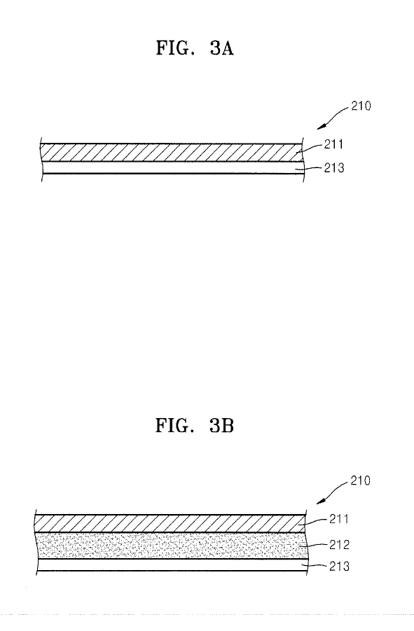

FIG. 3A is a cross-sectional view of an example of the endless belt 210. Referring to FIG. 3A, the endless belt 210 may include a substrate 211 in the form of a film. The substrate 211 may be a thin metal film such as a thin stainless-steel film or a thin nickel film. The substrate 211 may be a polymer film, such as a polyimide film, a polyamide film, or a polyimide-amide film, which has heat resistance and wear resistance to a fixing temperature, for example, a temperature of 120° C. through 200° C. A thickness of the substrate 211 may be determined to have flexibility and elasticity so that the endless belt 210 may be flexibly deformed at the fixing nip 201 and, after passing through the fixing nip 201, return to an original state. For example, the thickness of the substrate 211 may be about 30 through 200 μm, and may be about 75 through 100 μm. Wherein the endless belt 210 is deformed the width of the heating unit 400 as the endless belt 210 contacts the back-up member 230.

An outermost layer of the endless belt 210 may be a release layer 213. An offset, in which toner on the recording medium P melts in a fixing process and attaches to the endless belt 210, may be caused. The offset may cause inferior printing in which a part of a printing image on the recording medium P is missing or a jam in which the recording medium P, passing through the fixing nip 201, is not separated from the endless belt 210 and is attached to an outer surface of the endless belt 210. The release layer 213 may be a resin layer which has excellent separation characteristics. The release layer 213 may be, for example, one of materials such as perfluoroalkoxy (PFA), polytetrafluoroethylene (PTFE), and fluorinated ethylene propylene (FEP), a blend of two or more of the materials, or a copolymer thereof. The release layer 213 may be formed by covering the substrate 211 with a tube, made of the materials describe above, or coating the materials described above on a surface of the substrate 211. A thickness of the release layer 213 may be, for example, about 10 through 30 μm.

As illustrated in FIG. 3B, the endless belt 210 may further include an elastic layer 212. The elastic layer 211 may be disposed between the substrate 211 and the release layer 213. The elastic layer 212 functions to easily form the fixing nip 201, and may be formed of a material which has heat resistance to a fixing temperature. The elastic layer 212 may be formed of, for example, rubber such as fluoro rubber, silicone rubber, natural rubber, isoprene rubber, butadiene rubber, nitrile rubber, chloroprene rubber, butyl rubber, acrylic rubber, hydrin rubber, and urethane rubber. The elastic layer 212 may also be formed of one of various thermoplastic elastomers such as stylenes, polyolefins, polyvinyl chlorides, polyurethanes, polyamides, polybutadienes, trans-polyisoprenes, and chlorinated polyethylenes, or a blend or a copolymer thereof. A thickness of the elastic layer 211 may be, for example, about 10 through 100 μm.

The heating unit 400 is disposed inside the endless belt 210. The back-up member 230 is disposed outside the endless belt 210, to face the heating unit 400. The heating unit 400 and the back-up member 230 press each other with the endless belt 210 therebetween. For example, a pressing force may be applied, toward the back-up member 230, to both sides of a width of the heating unit 400 which is perpendicular to a moving direction of the endless belt 210, by using a first pressing element, e.g., a spring 250. As illustrated in FIG. 2, the spring 250 may press the heating unit 400 by interposing a pressing bush 251 therebetween. A pressing force may be applied to the back-up member 230 toward the heating unit 400 by using a second pressing element, for example, a spring 231. The back-up member 230 may move the endless belt 210. For example, the back-up member 230 may be a pressing roller in which an elastic layer is provided on an outer circumference of a metal core. The back-up member 230 may move the endless belt 210 by rotating in a pressed state, having the endless belt 210 disposed between the back-up member 230 and the heating unit 400. The heating unit 400, together with the back-up member 230, forms the fixing nip 201. The heating unit 400 also guides to move the endless belt 210. A belt guide 240 may be further provided outside the fixing nip 201, so as to guide the endless belt 210 to move smoothly. The belt guide 240 may be formed integrally with the heating unit 400, or formed of a member separate from the heating unit 400.

The heating unit 400 includes a support member 220 which faces the back-up member 230 and forms the fixing nip 201, and a heater 300 which heats the endless belt 210 at the fixing nip 201. That is, with regard to the heating unit 400 in the current embodiment, the support member 220 for forming the fixing nip 201 is formed integrally with the heater 300. Additionally, the heater 300 in the current embodiment is a flexible heater with elasticity.

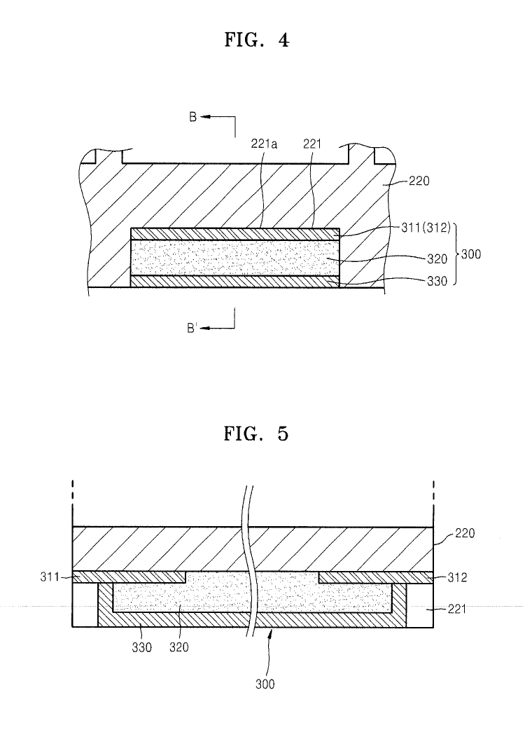

FIG. 4 is a detailed diagram illustrating a portion A of FIG. 2. FIG. 5 is a cross-sectional view of the fixing apparatus 200 taken along line B-B′ of FIG. 4. Referring to FIGS. 2, 4, and 5, a recess 221 is provided at a location which corresponds to the fixing nip 201 of the support member 220. The recess 221 is concave from a surface which faces the back-up member 230 of the support member 220, and extends to a direction of a length perpendicular to a moving direction of the endless belt 210. The heater 300 is located in the recess 221. The heater 300 may include a heating element 320, and current-supplying electrodes 311 and 312 for supplying current to the heating element 320. The heater 300 may further include an insulating layer 330 covering the heating element 320. The current-supplying electrodes 311 and 312 are respectively located on both ends of a length of the recess 221 and are separate from each other. The current-supplying electrodes 311 and 312 may be formed of, for example, low-resistance metal. The heating element 320 is located on a bottom 221a of the recess 221 and contacts the current-supplying electrodes 311 and 312 and, and extends in a direction of a length of the recess 221. The insulating layer 330 is disposed on the heating element 320. The insulating layer 330 covers the heating element 320, and may cover a part of the current-supplying electrodes 311 and 312, as illustrated in FIG. 5, so as to cover both ends of a length of the heating element 320. A part of the current-supplying electrodes 311 and 312 is exposed to be connected to a power supply device which is not illustrated.

The insulating layer 330 may be a polymer layer, which has high heat resistance and an electrical insulation. For example, the insulating layer 330 may be a polyimide (PI) resin layer. The insulating layer 330 may have, for example, a withstand voltage higher than about 3 kV. A thickness of the PI resin layer may be about 20 through 70 μm. As a result of evaluating a withstand voltage, the PI resin layer has a withstand voltage of equal to or higher than about 3 kV at a thickness of equal to or more than about 20 μm. Accordingly, the thickness of the PI resin layer may be determined to be higher than about 20 μm by considering characteristics of the withstand voltage, and to be within about 70 μm by considering characteristics of thermal conduction. In an embodiment, a thickness of the PI resin layer, as the insulating layer 330, may be about 20 through 50 μm.

The heating element 320 may include a base polymer and an electrically conductive filler, which is distributed in the base polymer. A base polymer is a material which has heat resistance to a fixing temperature, and is not specially limited otherwise. For example, a base polymer may be a heat-resistant resin or a heat-resistant elastomer. A heat-resistant resin may be PI or polyimide-amide. A heat-resistant elastomer may be a silicone elastomer or a fluoroelastomer. A base polymer may be one of such materials, or a blend or a copolymer thereof.

One or two types of an electrically conductive filler may be distributed in the base polymer. A metal filler such as metal particles or a carbon filler may be employed as an electrically conductive filler. An electrically conductive filler may include carbon black, a carbon nanotube (CNT), a cup-stacked carbon nanotube, a carbon fiber, a carbon nanofiber, a carbon nanocoil, fullerene, graphite, expanded graphite, graphite nanoplatelet, or graphite oxide (GO). An electrically conductive filler may be one of such materials, or a combination thereof.

An electrically conductive filler is distributed in the base polymer, so as to form an electrically conductive network. Thus, the heating layer 320 may be an electrical conductor or a resistor. For example, since the CNT has a conductivity similar to metal but a very low density, a heat capacity per unit volume of the CNT is 3 to 4 times lower than that of general resistant materials. This means that the heating layer 320, which employs the CNT as a conductive filler, may have a very rapid change in temperature. Accordingly, by using such a type of the heater 300, time for switching from a standby mode to a printing mode may be reduced. Thus, first printing may be performed rapidly.

A thickness of the heating element 320 varies according to a specific resistance of the electrical conductive filler, and a resistance required by the entire heater 300. For example, the thickness of the heating element 320 may be 50 μm through 300 μm. As an embodiment, if a multi-walled carbon nanotube (MWNT) is employed as an electrical conductive filler, a content of the electrical conductive filler may be about 10 through 40 wt %, and a thickness of the heating element 320 may be about 100 μm through 200 μm.

Hereinafter, an embodiment of a method of forming a flexible heater 300 integrally with the support member 220 is described.

First, the support member 220, which includes the recess 221, is prepared. The support member 220 may be formed of an electrically insulating material which has heat resistance to a fixing temperature and a heat treatment process temperature which will be described later, and has the strength to endure an applied pressure for forming the fixing nip 201. The support member 220 may be formed of porous materials, so as to improve the bonding strength between the heating element 320 and the support member 220 in a process of forming the heater 300.

Then, the current-supplying electrodes 311 and 312 are respectively located on both sides of a length of the bottom 221a of the recess 221, so as to be separate from each other. A method of placing the current-supplying electrodes 311 and 312 on the recess 221 is not specially limited. For example, low-resistance metal may be directly coated on the recess 221. Alternatively, a low-resistance metal thin film may be attached to the bottom 221a of the recess 221. Otherwise, a low-resistance metal thin film may be combined to the recess 221 by using a combining member.

Then, the heating element 320 is formed. A solution is prepared by mixing and distributing a polymer precursor for forming a base polymer and an electrically conductive filler for forming an electrically conductive network in a solvent. The solution may be in a paste form which has viscosity. The prepared solution is applied to the recess 221, and a heat treatment process for hardening is executed. The heat treatment process may include a first curing process for forming a base polymer according to a chemical reaction of the polymer precursor and strengthening chemical bonding between polymers, and a second curing process for discharging a volatile component. A condition of the heat treatment process may be appropriately determined according to a type of the base polymer. For example, in a case of silicone rubber, the first curing process may be performed at a temperature of 150° C. for about 20 minutes, and the second curing process may be performed at a temperature of 220° C. for about 4 hours. The polymer precursor is solidified by performing the heat treatment process, and becomes a base polymer. The base polymer has a strong adhesive force to the electrically conductive filler which is distributed in the base polymer, thus fixing the electrically conductive filler in the base polymer. Therefore, the electrically conductive filler is prevented from moving in the base polymer. Additionally, since a structure of an electrically conductive filler for forming the electrically conductive network, for example, a graphene structure with π-π* bonding is not destroyed, the heating element 320 with an excellent reactivity to an input voltage, that is, a heating speed, may be obtained.

The solution is hardened in contact with the current-supplying electrodes 311 and 312 in the recess 221 through a heat treatment process, so as to form the heating element 320. Thus, the heating element 320 and the current-supplying electrodes 311 and 312 may be bonded without having to use a conductive primer. Accordingly, the heater 300 may be manufactured to have a low resistance between the current-supplying electrodes 311 and 312 and the heating element 320 and an excellent adhesive force.

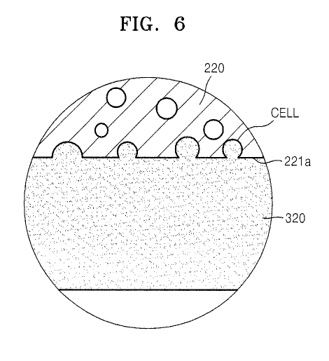

When employing the support member 220 which is formed of a porous material, the solution applied to the recess 221 penetrates into a cell which is exposed at the bottom 221a of the recess 221. Then the solution is hardened in the cell in the form of a polymer through a heat treatment process, as illustrated in FIG. 6. Therefore, the bonding strength between the heating element 320 and the support member 220 may be improved, after the heat treatment process.

A process of forming the insulating layer 330 as necessary may be performed. The insulating layer 330 may be formed by coating the heating element 320 with an insulating material, applying an insulating material to the heating element 320, or attaching an insulating film to the heating element 320. The insulating layer 330 may be formed only on the heating element 320. Also, the insulating layer 330 may extend to a part of the current-supplying electrodes 311 and 312 in a direction of a length of the insulating layer 330 so as to cover both ends of a length of the heating element 320. Though not illustrated, the insulating layer 330 may be formed on an entire surface which faces the back-up member 230 of the support member 220.

The insulating layer 330 may be formed of the same polymer as the base polymer of the heating element 320. By doing so, a chemical affinity between the insulating layer 330 and the heating element 320 may be increased, and thus, a bonding strength therebetween may be improved.

As illustrated in FIG. 2, the heater 300 may directly contact the inside surface of the endless belt 210 so as to heat the endless belt 210. In such a configuration, the endless belt 210, located between the heater 300 and the back-up member 230, may be directly heated at the fixing nip 201 by using the heater 300. Thus, by reducing heat loss, high heat efficiency may be achieved and power consumption may be reduced. Additionally, a rapid rise in temperature may be obtained by employing the endless belt 210, which has a very low heat capacity. By applying a lubricant, for example, grease, between the endless belt 210 and the heating unit 400, that is, the endless belt 210 and the support member 220, a friction between the endless belt 210 and the support member 220 may be reduced, and thus, abrasion and resultant damage of the endless belt 210 and the support member 220 may be reduced.

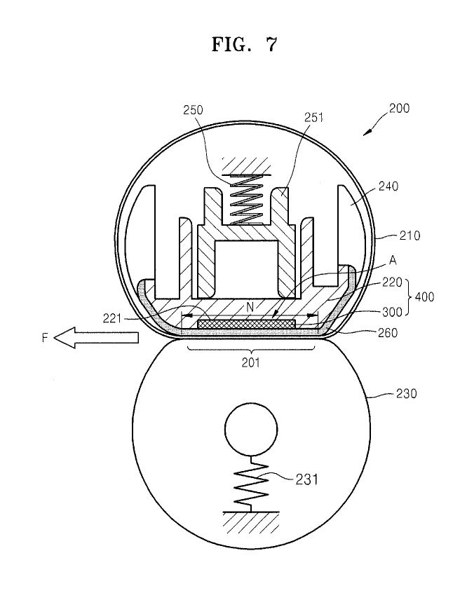

FIG. 7 is a cross-sectional view of an embodiment of the fixing apparatus 200, according to the present invention. Unlike a previous embodiment, the fixing apparatus of FIG. 7, in the current embodiment, includes a heat-conductive plate 260, which is interposed between the heater 300 and the endless belt 210. The heat-conductive plate 260 may be, for example, a thin metal plate. By interposing the heat-conductive plate 260 between the heater 300 and the endless belt 210, heat from the heater 300 may be uniformly transferred to the endless belt 210. Additionally, by keeping a width of the heat-conductive plate 260 to be equal to or more than a width N of the fixing nip 201, a range of heat transfer to the recording medium P may be expanded and fixing characteristics may be further improved. In such a case, a lubricant may be applied between the endless belt 210 and the heat-conductive plate 260.

As an example, with regard to a heater in which a belt is heated directly at a fixing nip, a ceramic heater (not illustrated) may be considered. The ceramic heater has a structure in which a metal heating-element pattern layer is disposed on an insulating ceramic substrate, and an insulating layer is disposed on the metal heating-element pattern layer. Alumina (Al₂O₃), aluminum nitride (AlN), or the like may be mainly used for the ceramic substrate, and silver/palladium (Ag—Pd) alloy may be used for the metal heating-element pattern layer. A glass layer is mainly used as the insulating layer. An electrode is disposed on the ceramic substrate to supply current to the metal heating-element pattern layer. The electrode may be connected to, for example, a power supply device by using, for example, a connector.

As formed of a ceramic substrate, the ceramic heater may be sensitive to pressure, and may be easily damaged due to an unbalanced pressing force. If an unbalance in the pressing force is caused by an uneven fixing nip or a relatively inaccurate pressure structure, the ceramic heater may be damaged. Additionally, since the heating-element pattern layer is formed of a very thin metal film, an unbalance in the pressing force may cause to break the heating-element pattern layer and electrical disconnection of the heating-element pattern layer. Therefore, there may be a lot of restrictions on designing a shape of the fixing nip and a pressure structure.

With regard to a fixing apparatus which is controlled at a predetermined temperature, the ceramic heater may be severely deformed, that is, expanded or shrunk, by heat in an environment with drastic temperature changes. Therefore, the heat-element pattern layer in the form of a thin metal film may be broken. Additionally, heat deformation of a ceramic heater may cause friction between the electrode and a connector, thus resulting in abrasion of a surface of an electrode, excessive heating of the electrode, and thereby increasing a possibility of damaging the ceramic heater. Additionally, abrasion of the belt may be caused by friction between a surface of the expanded heater and the belt. Especially, abrasion of the electrode and abrasion of the belt are very serious, as it is related to a stability of the fixing apparatus.

When a paper jam is generated, a pressing force for forming a fixing nip may be released in order to remove the paper. A pressing force is applied to both ends of the ceramic heater. When the pressing force is released, a central part, in a direction of a length of the ceramic heater, may be deflected. When the paper is pulled and removed in this state, the belt and the central part of the ceramic heater may rub each other, thus damaging the belt and/or the ceramic heater.

Additionally, in a shape of the flat fixing nip, it is not easy to realize a structure for removing a wrap jam in which paper, passing through the fixing nip, is not separated from the belt and is jammed in the belt.

In the current embodiment, the heating unit 400 and the fixing apparatus 200 employ the flexible heater 300, as described above. Since the flexible heater 300 may absorb an unbalanced pressure through its own flexible deformation, the heater 300 and the support member 220 for supporting the heater 300 may not be damaged, and thus, an accuracy of a pressure structure may be reduced, and the pressure structure may be simplified. Additionally, the flexible heater 300 may be freely expanded and shrunk by heat, and heat deformation of the heating element 320 may not influence the support member 220 and the current-supplying electrodes 311 and 312. Accordingly, a possibility of damage on the support member 220 and a possibility of a friction between the current-supplying electrodes 311 and 312 and a power supply connector (not illustrated) connected to the current-supplying electrodes 311 and 312 are very low. Compared to the ceramic heater, the flexible heater 300 may also lower a possibility of damaging the endless belt 210 due to friction between the flexible heater 300 and the endless belt 210. A possibility of damaging the endless belt 210 due to friction between the flexible heater 300 and the endless belt 210 may be also decreased by applying a lubricant, for example, grease, between the endless belt 210 and the heater 300.

Additionally, as described above, by forming the flexible heater 300 and the support member 220 in the same body in the form of the heating unit 400, it is possible to omit a process of bonding the flexible heater 300 with the support member 220 in a process of manufacturing a fixing apparatus. Thus, a manufacturing process may be simplified, and the fixing apparatus may be compact in size.

According to a fixing apparatus which employs the flexible heater 300, the flexible heater 300 may be smoothly bend according to a shape of the fixing nip 201, and thus, a design freedom of the fixing nip 201 may be increased. Accordingly, the fixing nip 201 may be formed in various forms for improving heat efficiency and fixing characteristics. Additionally, various forms of the fixing nip 201, which are suitable for preventing a wrap jam to improve separation characteristics, may be implemented.

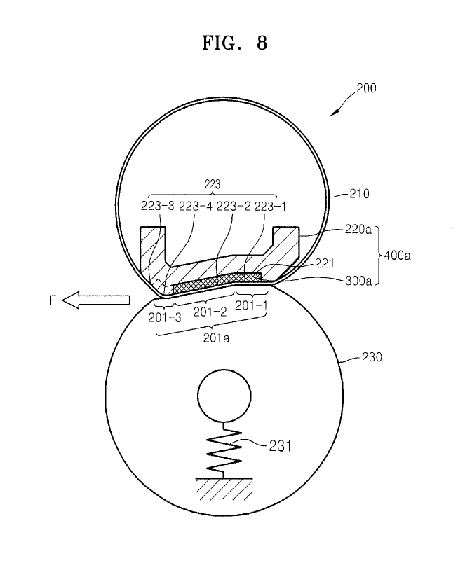

FIG. 8 is a cross-sectional view of an embodiment of the fixing apparatus 200. Unlike the fixing apparatus of FIGS. 2 and 7, with regard to the fixing apparatus in the current embodiment, a heating unit 400a forms an uneven fixing nip 201a. The spring 250 and the pressing bush 251 for pressing the heating unit 400a toward the back-up member 230 are not illustrated in FIG. 8. The heating unit 400a includes a support member 220a, and a flexible heater 300a which is formed in the recess 221 of the support member 220a integrally. Though the flexible heater 300a has a shape different from the flexible heater 300 of FIGS. 4 and 5, a structure and a manufacturing method of the flexible heater 300a are the same as the flexible heater 300 of FIGS. 4 and 5. The flexible heater 300a directly contacts the inside surface of the endless belt 400a and heats the endless belt 210.

The fixing nip 201a, formed by disposing the support member 220a and the back-up member 230 to face each other, may include at least two nip areas which form an angle with each other. The at least two nip areas, which form an angle with each other, mean that at least two nip areas are not the same flat or curved surface. In other words, angles of the two nip areas to a recording medium transporting direction F are different from each other. For example, the fixing nip 201a may include a first nip area 201-1 at an entrance, and a second nip area 201-2 which extends towards an exit by forming an angle with the first nip area 201-1. The first nip area 201-1 and the second nip area 201-2 may be formed to incline downwardly toward the back-up member 230 along the recording medium transporting direction F. The first nip area 201-1 and the second nip area 201-2 may be respectively in a flat or curved form. The form of the fixing nip 201a is not limited to the example illustrated in FIG. 8, and may be various forms for increasing heat efficiency and improving fixing characteristics at the fixing nip 201a. The flexible heater 300a in the current embodiment is a flexible heater which employs the heating element 320 in the form of a base polymer/electrically conductive filler. The flexible heater 300a may be manufactured in various forms according to a shape of the recess 221, by using the manufacturing process described above. Therefore, the freedom of a shape of the fixing nip 201a may be improved, and the endless belt 210 may be uniformly heated even at the fixing nip 201a, which has an uneven shape.

A protruding area 201-3, which protrudes towards the back-up member 230 and has rapidly changing curvature, may be provided near the exit of the fixing nip 201a. If the recording medium P passes through the fixing nip 201a, and is not separated from the endless belt 210 due to an adhesive force between a toner melt on the recording medium P and the endless belt 210, a wrap jam may be caused. However, the curvature of the endless belt 210 rapidly changes at the exit of the fixing nip 201a because of the protrusion area 201-3. Thus, due to stiffness of the recording medium P, the recording medium P may be easily separated from the endless belt 210. Accordingly, the wrap jam, caused when the recording medium P passing through the fixing nip 201 is jammed in the belt, may be reduced.

As an embodiment, the form of the fixing nip 201a of FIG. 8 may be implemented by the shape of the support member 220a. Referring to FIG. 8, the support member 220a includes a nip forming unit 223 which faces the back-up member 230 and forms the fixing nip 201a. The nip forming unit 223 may include a first nip forming unit 223-1, and a second nip forming unit 223-2 which forms an angle with the first nip forming unit 223-1. The first and second nip forming units 223-1 and 223-2 correspond respectively to the first and second nip areas 201-1 and 201-2. The first and second nip forming units 223-1 and 223-2 may be formed to incline downwardly toward the back-up member 230. The first and second nip forming units 223-1 and 223-2 may be respectively in a flat or curved form. The recess 221 may be provided in a form to correspond to a shape of the fixing nip 201a, over the first and second nip forming units 223-1 and 223-2. The nip forming unit 223 may include a third nip forming unit 223-3 which extends away from the back-up member 230 from the second nip forming unit 223-2, that is, towards the endless belt 210, and forms a protrusion area 223-4 protruding towards the back-up member 230 between the second nip forming unit 223-2 and the third nip forming unit 223-3. The protrusion area 201-3, which protrudes towards the back-up member 230, may be formed near the exit of the fixing nip 201a by the protruding area 223-4.

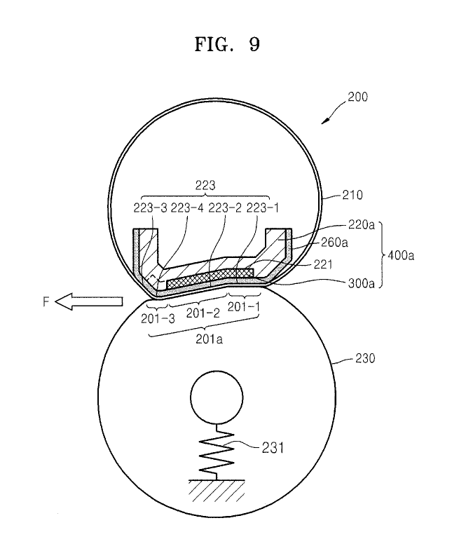

FIG. 9 is a cross-sectional view of a modified embodiment of the fixing apparatus of FIG. 8, according to the present invention. Except for a heat-conductive plate 260a interposed between the support member 220a and the endless belt 210, the current embodiment of the fixing apparatus is the same as an embodiment of the fixing apparatus of FIG. 8. The heat-conductive plate 260a may be provided to correspond to at least the first and second nip areas 201-1 and 201-2. Additionally, the heat-conductive plate 260a may extend to a location which corresponds to the protrusion area 201-3. Thus, heat from the heater 300a may be transferred to the protrusion area 201-3, so as to improve fixing and separation characteristics. The heat-conductive plate 260a may be, for example, a thin metal plate. By interposing the heat-conductive plate 260a between the heater 300a and the belt 210, heat from the heater 300a may be uniformly transferred to the belt 210. Additionally, by keeping a width of the heat-conductive plate 260a to be more than a width N of the fixing nip 201a, a range of heat transfer to the recording medium P may be expanded and fixing characteristics may be further improved.

As illustrated by dashed lines in FIGS. 8 and 9, the recess 221 may extend to or beyond a location which corresponds to the protrusion area 201-3. Accordingly, the heater 300a may be formed at a location which corresponds to the protrusion area 201-3, and thus, heat may be effectively transferred to the recording medium P even in the protrusion area 201-3. Therefore, fixing characteristics, as well as separation characteristics, may be improved.

While the present disclosure has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A heating unit for a fixing apparatus, the heating unit comprising:
a support member having a recess formed in one surface thereof;
current-supply electrodes respectively disposed at both ends of a length of the recess; and
a heating element formed in the recess to contact the current-supply electrodes, the heating element including a base polymer and an electrically-conductive filler distributed in the base polymer to form an electrically-conductive network in a base polymer.

2. The heating unit of claim 1, wherein the heating element is filled in the recess in the form of a solution in which a polymer precursor for forming the base polymer and the electrically-conductive filler are distributed, and is hardened and formed in the recess.

3. The heating unit of claim 2, wherein the support member is formed of a porous material.

4. The heating unit of claim 1, further comprising an insulating layer which covers the heating element.

5. A method of manufacturing a heating unit for a fixing apparatus, the method comprising:
preparing a support member having a recess;
disposing current-supply electrodes respectively at both ends of a length of the recess;
filling the recess with a solution in which a polymer precursor and an electrically-conductive filler are distributed; and
by hardening the polymer precursor through a heat treatment process, forming a heating element including a base polymer and an electrically-conductive filler distributed in the base polymer to form an electrically-conductive network in a base polymer, in the recess.

6. The method of claim 5, wherein the filling of the recess comprises penetrating the solution into cells exposed at a bottom of the recess.

7. The method of claim 5, further comprising forming an insulating layer which covers the heating layer.

8. A fixing apparatus comprising:
a endless belt which is rotatable and flexible;
a back-up member which is disposed outside the endless belt and moves the endless belt; and
a heating unit which is located inside the endless belt to face the back-up member and form a fixing nip, and heats the endless belt at the fixing nip,
wherein the heating unit comprises
a support member in which a recess is provided at a location corresponding to the fixing nip; and
a heater which comprises current-supply electrodes respectively disposed at both ends of a length of the recess, and a heating element which is formed in the recess to contact the current-supply electrodes, the heater including a base polymer and an electrically-conductive filler distributed in the base polymer to form an electrically-conductive network in a base polymer.

9. The fixing apparatus of claim 8, wherein the heating element is filled in the recess in the form of a solution in which a polymer precursor for forming the base polymer and the electrically-conductive filler are distributed, and is hardened and formed in the recess.

10. The fixing apparatus of claim 8, wherein the support member is formed of a porous material.

11. The fixing apparatus of claim 8, wherein the heater contacts the inside surface of the endless belt.

12. The fixing apparatus of claim 8, wherein a heat-conductive plate is interposed between the heater and the endless belt.

13. The fixing apparatus of claim 12, wherein a width of the heat-conductive plate is greater than a width of the fixing nip.

14. The fixing apparatus of claim 8, wherein the fixing nip comprises at least two nip areas which form an angle with each other.

15. The fixing apparatus of claim 14, wherein a protrusion area, which protrudes towards the back-up member, is provided near an exit of the fixing nip.

16. The fixing apparatus of claim 15, wherein the recess extends to a location which corresponds to the protrusion area, and the heater is formed to extend to a location which corresponds to the protrusion area.

17. The fixing apparatus of claim 14, wherein a heat-conductive plate is interposed between the heater and the endless belt, and the heat-conductive plate extends to a location which corresponds to the protrusion area.

18. The fixing apparatus of claim 8, wherein the heater comprises an insulating layer which covers the heating layer.

19. An image forming apparatus comprising:
a printing unit for forming a visual toner image on a recording medium; and
the fixing apparatus of claim 8, for fixing the toner image to the recording medium.

20. The image forming apparatus of claim 19, wherein the heater comprises an insulating layer covering the heating layer.
